(19) United States
(12) Patent Application Publication
(10) Pub. No.: US 2005/0071737 A1
(43) Pub. Date: Mar. 31, 2005

(54) Business performance presentation user interface and method for presenting business performance

(75) Inventors: Michael Adendorff, Ottawa (CA); Thomas Fazal, Ottawa (CA); Kieran Del Pasqua, Ottawa (CA)

Correspondence Address: GARDNER GROFF, P.C.;PAPER MILL VILLAGE, BUILDING 23, 600 VILLAGE TRACE, SUITE 300, MARIETTA, GA, 30067, US

(73) Assignee: COGNOS INCORPORATED, OTTAWA (CA)

(21) Appl. No.: 10/675,679

(22) Filed: Sep. 30, 2003

(51) Int. Cl. G06F 17/00

(52) U.S. Cl. 715/500

(57) ABSTRACT

Business performance information is presented to users by displaying a list of Key Performance Indicators (KPIs) having delta indication scores indicating changes in the KPIs, providing display options, receiving selection of a display option, and presenting performance information of the KPIs based on the selected display option.

This invention relates to a user interface, and especially to a user interface and method for presenting business performance.

### BACKGROUND OF THE INVENTION

In order to manage a business, it is important to understand how the business is performing. Many organizations store various performance data, such as sales amounts, revenues and account receivables. Organizations use those data to evaluate their business performance.

There exist monitoring tools available for assisting users to monitor some performance data. Those, traditional monitoring tools are rigid in their presentation of data. Presentation is driven by an author's view on the business, rather than the performance metrics and their status. Those tools display only pre-set views of specific items as determined by an author of the tool at the time of implementation. Analysis of displayed values may be possible, but it is limited to the pre-set views of specific items. Also, in many organizations, each department has its own store of performance related data and its own definitions of metrics. Those tools may be sufficient for department heads to monitor the performance within the departments. However, those tools are often not sufficient for users who need to see a common, aligned view of business performance of the entire organization. Furthermore, traditional performance monitoring tools do not adapt well to changes in business priorities, initiatives and processes. An authored, rigid display of performance data must be frequently edited to keep up to date with business changes. Editing is cumbersome and requires special skills.

Some existing comprehensive systems provide functions for analysing problems, but those systems are too difficult to use without special training and their user interfaces are not sufficiently user friendly.

Also, in order to provide better views of business performance, scorecard systems are proposed. Scorecard systems give scores to values to indicate values are good or bad. This improves intuitive understanding of values. However, existing scorecard systems are suitable for a department scale analysis and do not give overall views or more in-depth view of the performance of their business.

It is therefore desirable to provide an improved user interface to allow users to easily monitor and analyse performance of their business

### SUMMARY OF THE INVENTION

It is an object of the invention to provide a novel user interface for monitoring business performance that obviates or mitigates at least one of the disadvantages of existing systems.

The invention uses scores calculated for various Key Performance Indicators (KPIs) to present business performance information to users. In an aspect, the invention presents monitored changes in KPIs. In another aspect, the invention allows viewers flexible sorting and/or filtering of KPIs during the monitoring operation.

In accordance with an aspect of the present invention, there is provided a method in a computer system for presenting business performance information. The method comprises steps of displaying a list of Key Performance Indicators (KPIs) having delta indication scores indicating changes in the KPIs; providing display options; receiving selection of a display option; and presenting performance information of the KPIs based on the selected display option.

In accordance with another aspect of the invention; there is provided a system for presenting business performance comprising a KPI provider for presenting a list of available predefined Key Performance Indicators (KPIs) having delta indication scores indicating changes in the KPI; an option provider for providing display options; a selection receiver for receiving selection of a display option; and a performance information provider for presenting performance information of the KPIs according to the selected display option.

In accordance with another aspect of the invention; there is provided a method in a computer system for presenting business performance information of an organization. The method comprises steps of displaying a list of Key Performance Indicators (KPIs) for an organization; receiving a selection of a specific KPI; providing analyzing method options, each analyzing method option defining an analyzing method of presenting performance information of KPIs to be analyzed; receiving a selection of an analyzing method; and presenting performance information of one or more KPIs including the specific KPI according to the selected analyzing method.

In accordance with another aspect of the invention; there is provided a performance information presenting system comprises a KPI provider for displaying a list of Key Performance Indicators (KPIs) for an organization; an option provider for providing analyzing method options, each analyzing method option defining an analyzing method of presenting performance information of KPIs to be analyzed; a selection receiver for receiving selections of a specific KPI and analyzing method; and a performance information provider for presenting performance information of one or more KPIs including the specific KPI according to the selected analyzing method.

In accordance with another aspect of the invention; there is provided a computer readable medium storing the instructions and/or statements for use in the execution in a computer of a method for presenting business performance information. The method comprises steps of displaying a list of Key Performance Indicators (KPIs) having delta indication scores indicating changes in the KPIs; providing display options; receiving selection of a display option; and presenting performance information of the KPIs based on the selected display option.

In accordance with another aspect of the invention; there is provided Electronic signals for use in the execution in a computer of a method for presenting business performance information. The method comprises steps of displaying a list of Key Performance Indicators (KPIs) having delta indication scores indicating changes in the KPIs; providing display options; receiving selection of a display option; and presenting performance information of the KPIs based on the selected display option.

In accordance with another aspect of the invention; there is provided a computer program product for use in the execution in a computer of a method for presenting business performance information. The computer program product comprises a module for displaying a list of Key Performance Indicators (KPIs) having delta indication scores indicating changes in the KPIs; a module for providing display options; a module for receiving selection of a display option; and a module for presenting performance information of the KPIs based on the selected display option.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1A is a diagram showing a business performance presentation system in accordance with an embodiment of the invention;

FIG. 1B is a flowchart showing a method for presenting business performance in accordance with an embodiment of the invention;

FIG. 1C is a diagram showing examples of presentations of performance information;

FIG. 1D is a diagram showing examples of organization of presentations of performance information;

FIG. 1E is a diagram showing another examples of organization of presentations of performance information;

FIG. 1F is a snapshot showing an example of grouping controls;

FIG. 1G is a partial snapshot showing an example of a dropdown dialog of grouping controls;

FIG. 1H is a partial snapshot showing an example of a single level grouping;

FIG. 11 is a partial snapshot showing an example of a two level grouping;

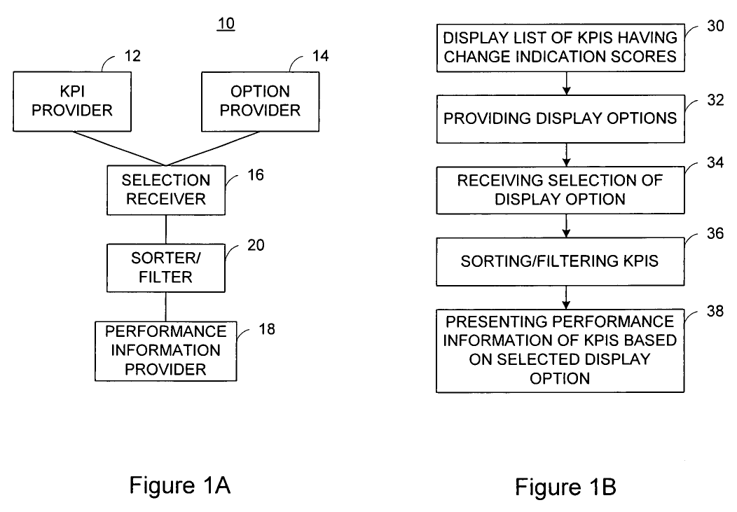

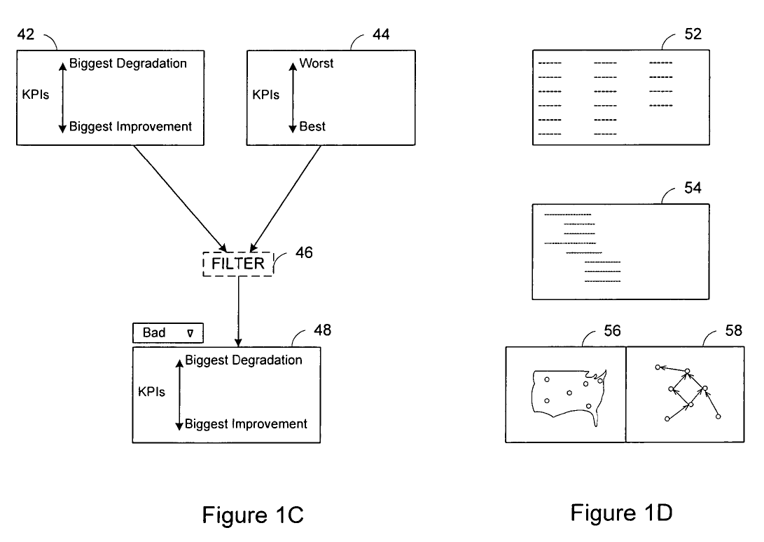

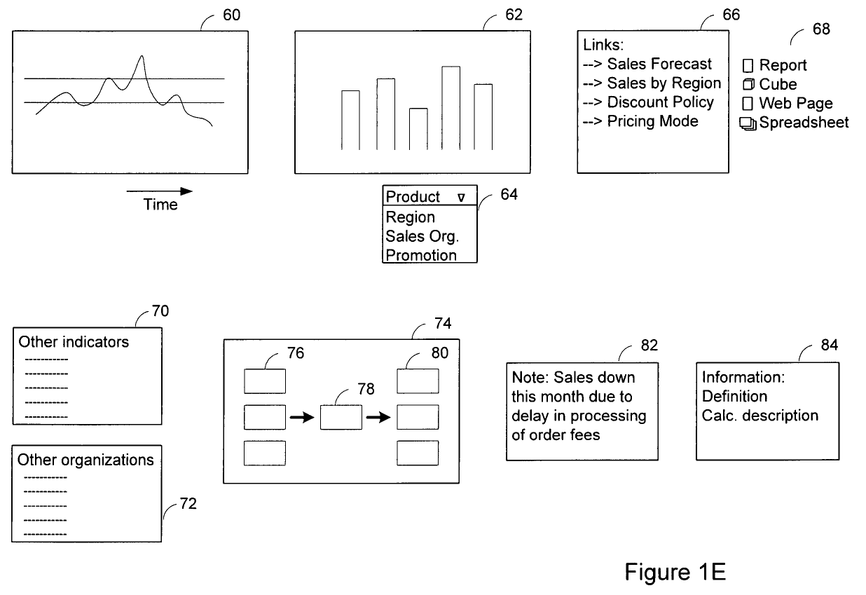

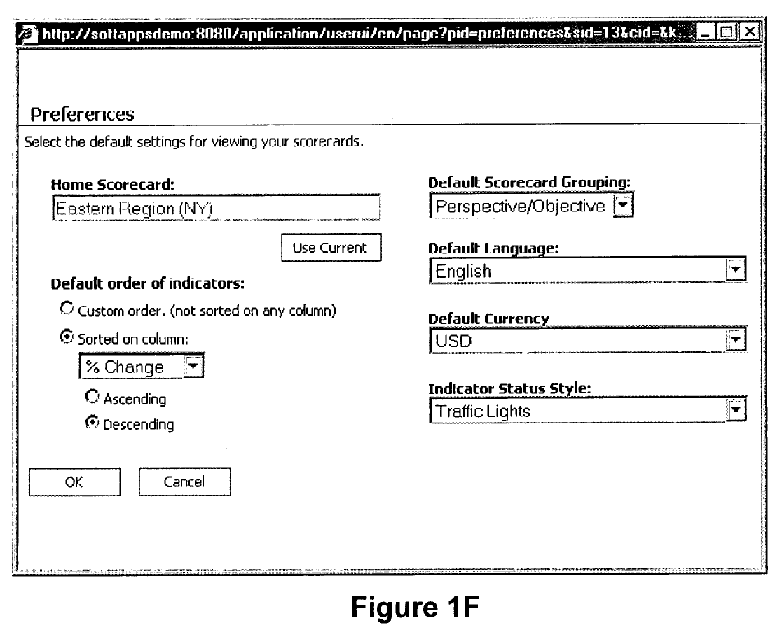

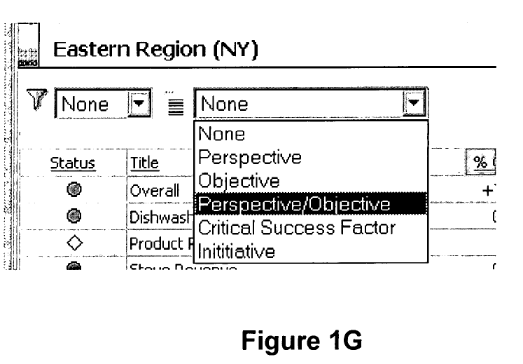

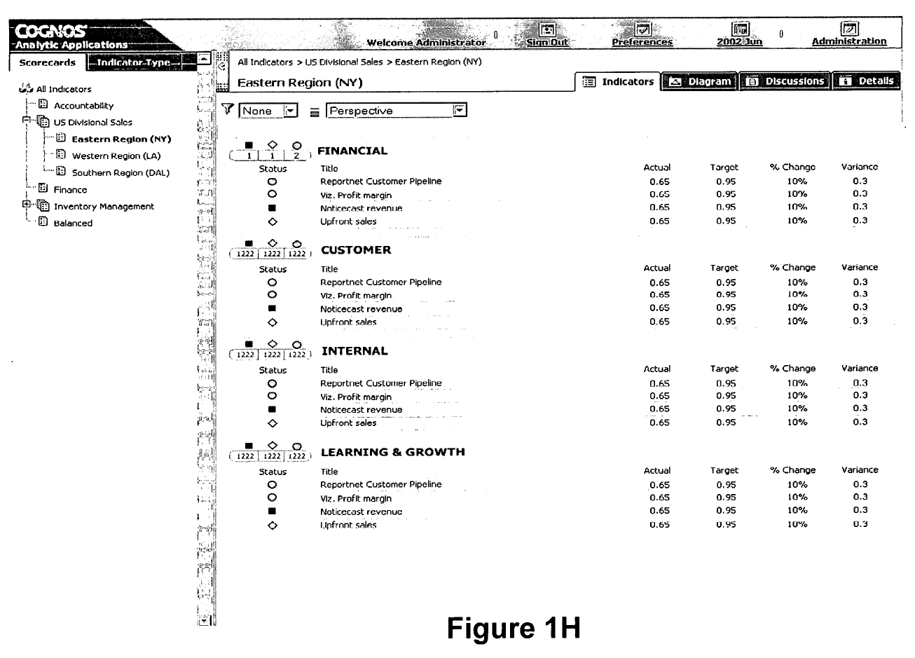

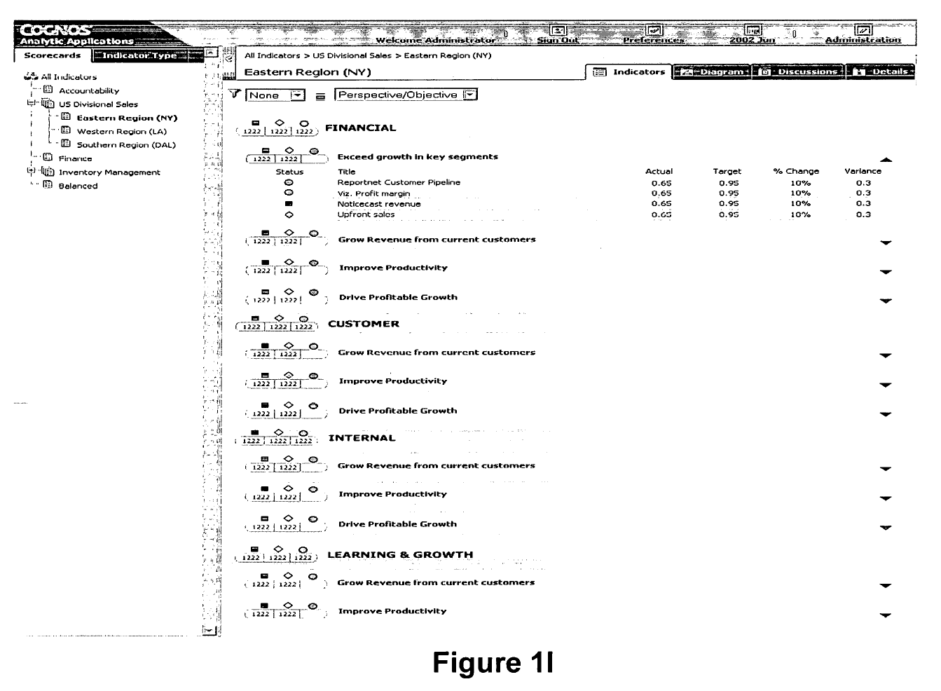

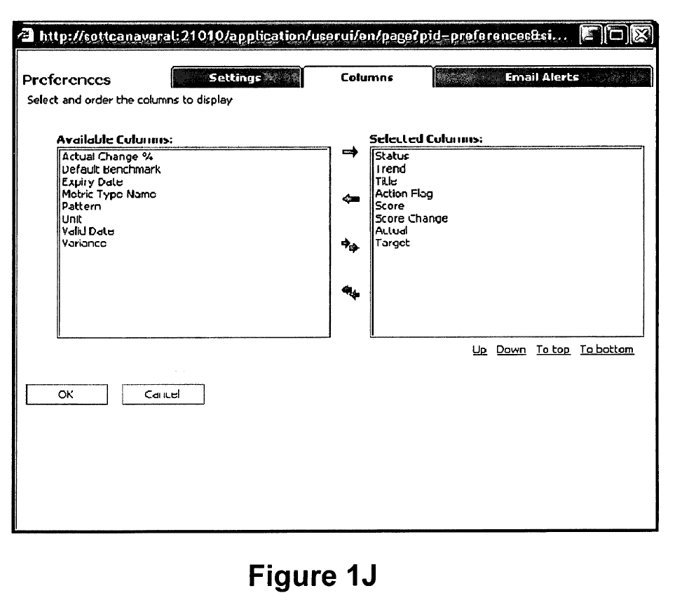

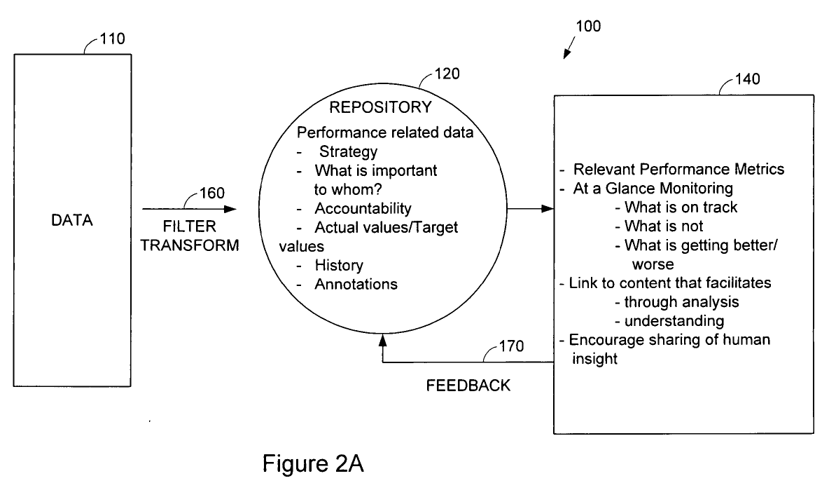

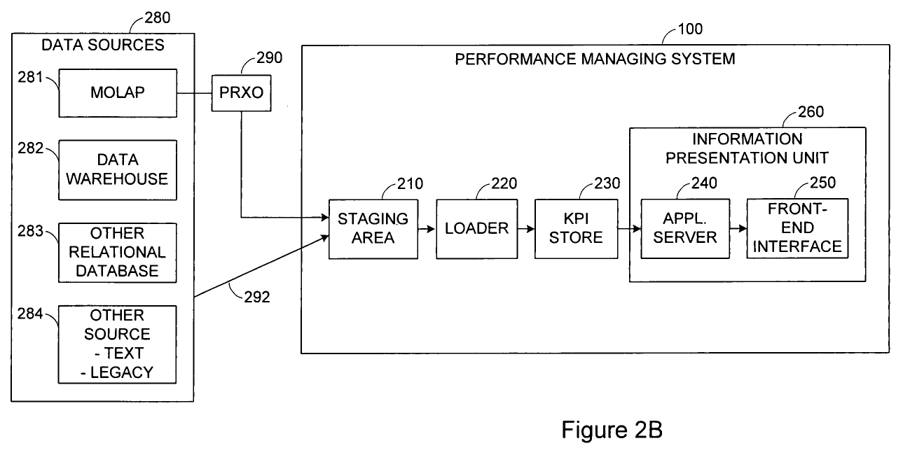

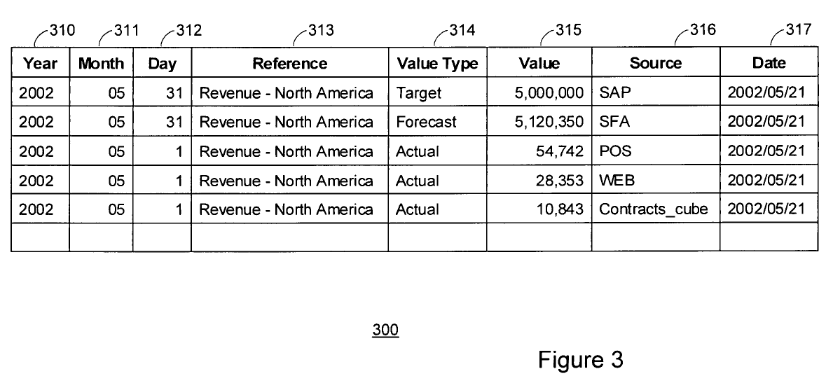

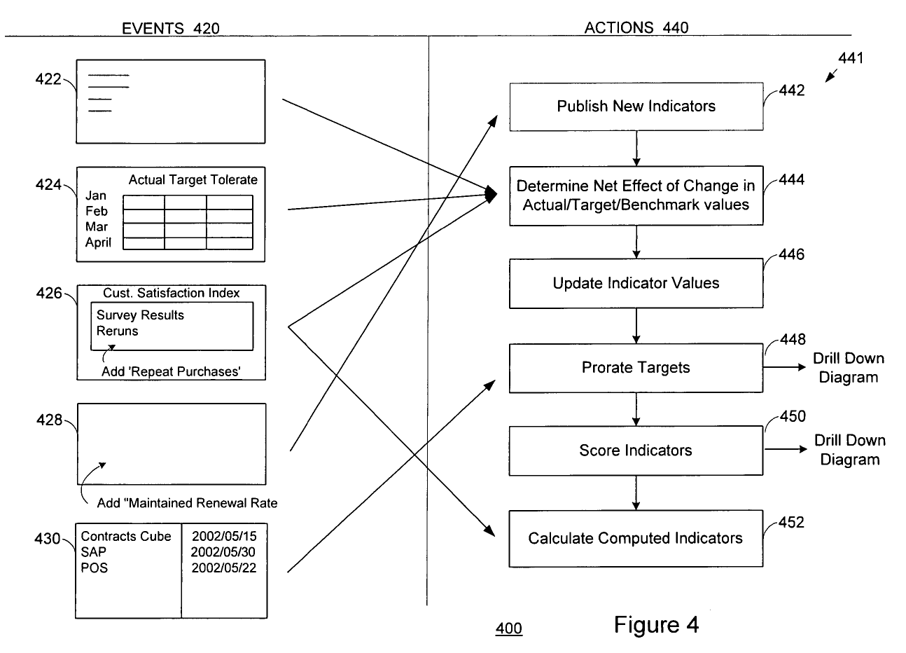

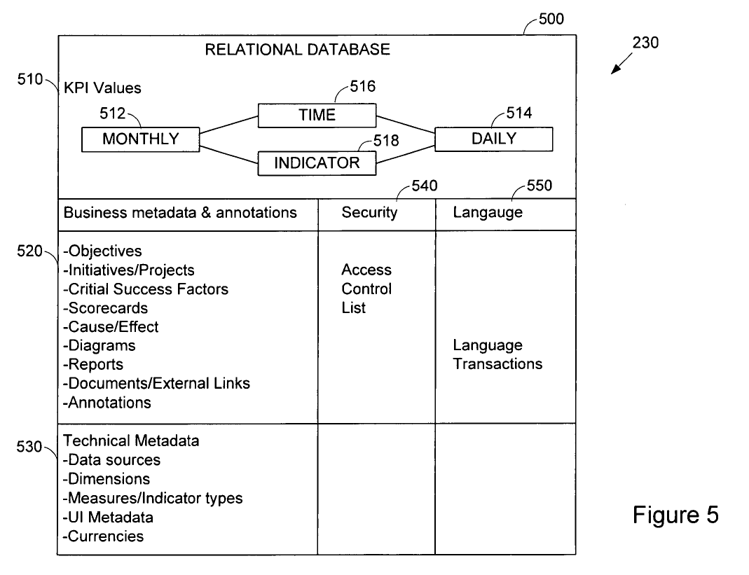

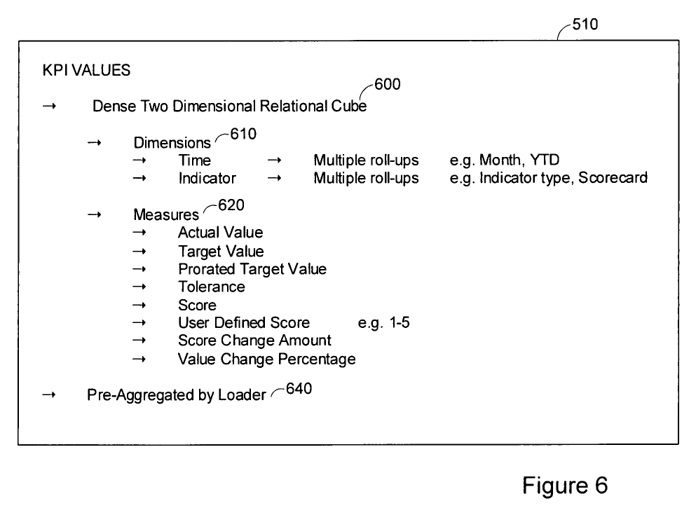

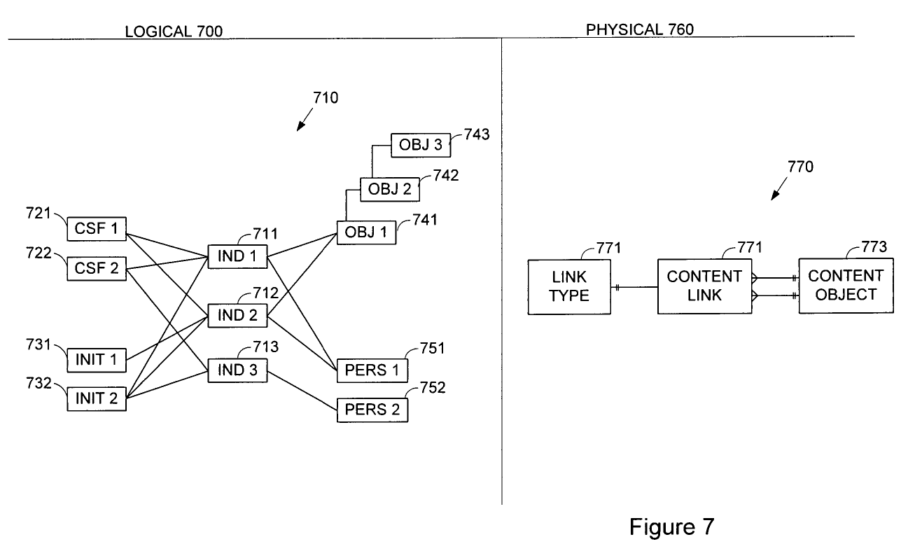

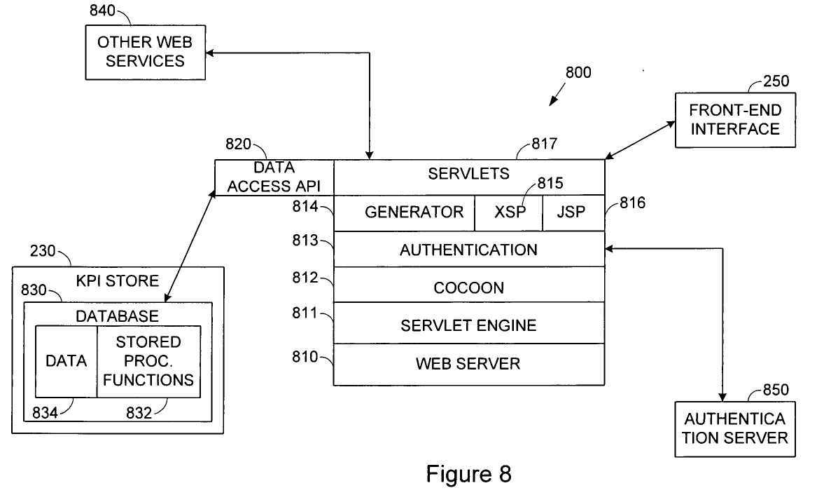

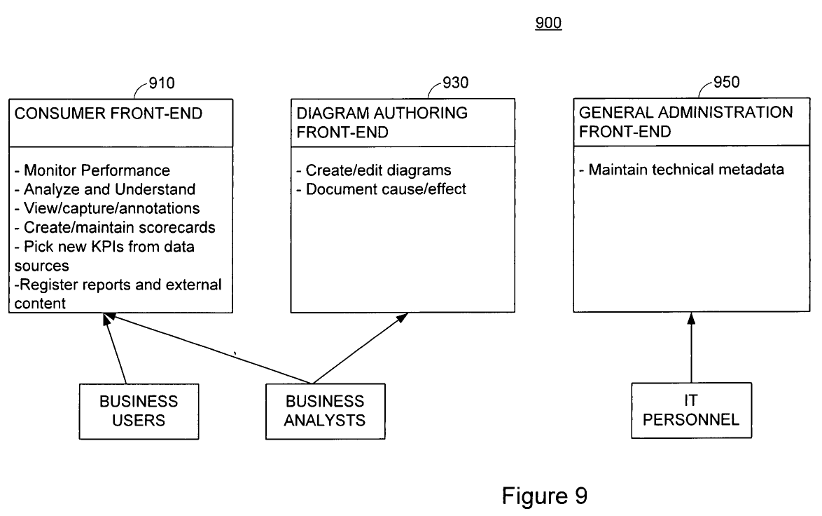

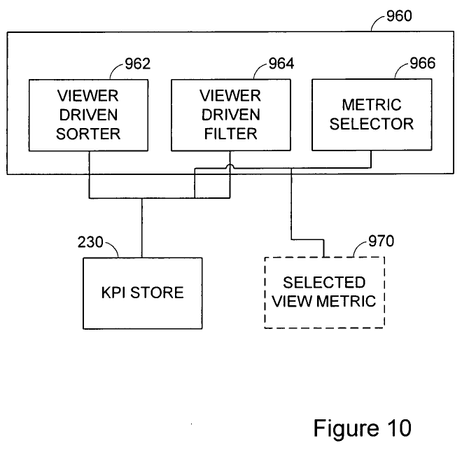

FIG. 1J is a partial snapshot showing an example of a column configuration dialog;

FIG. 2A is a diagram showing a business overview of a performance managing system in accordance with an embodiment of the invention;

FIG. 2B is a diagram showing a technical overview of the performance managing system shown in FIG. 1;

FIG. 3 is a diagram showing an example of a staging area data structure;

FIG. 4 is a diagram showing examples of events and actions carried out by a loader;

FIG. 5 is a diagram showing an example of a relational database of a KPI store;

FIG. 6 is a diagram showing examples of KPI values stored in the relational database;

FIG. 7 is a diagram showing an example of business metadata stored in the relational database;

FIG. 8 is a diagram showing an example of a web application server;

FIG. 9 is a diagram showing an example of a front-end interface;

FIG. 10 is a diagram showing an example of a consumer front-end interface;

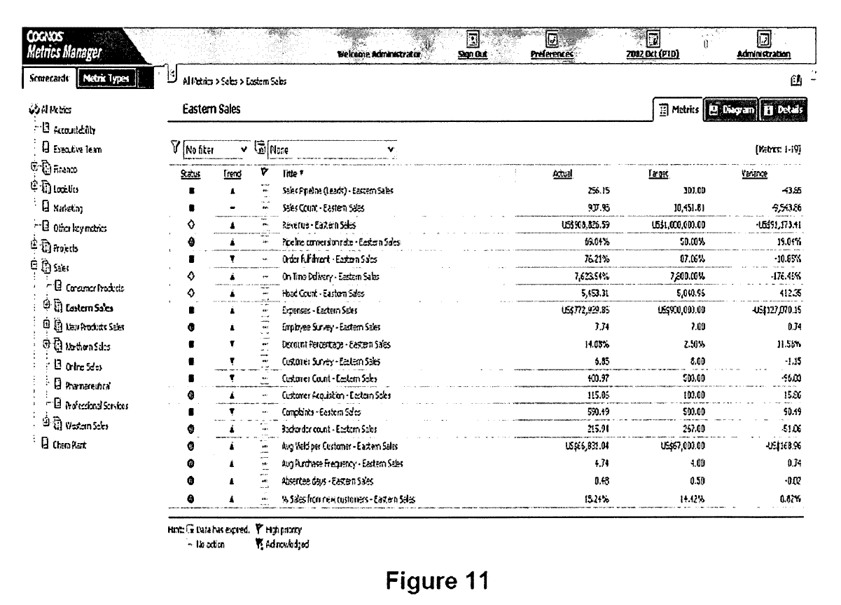

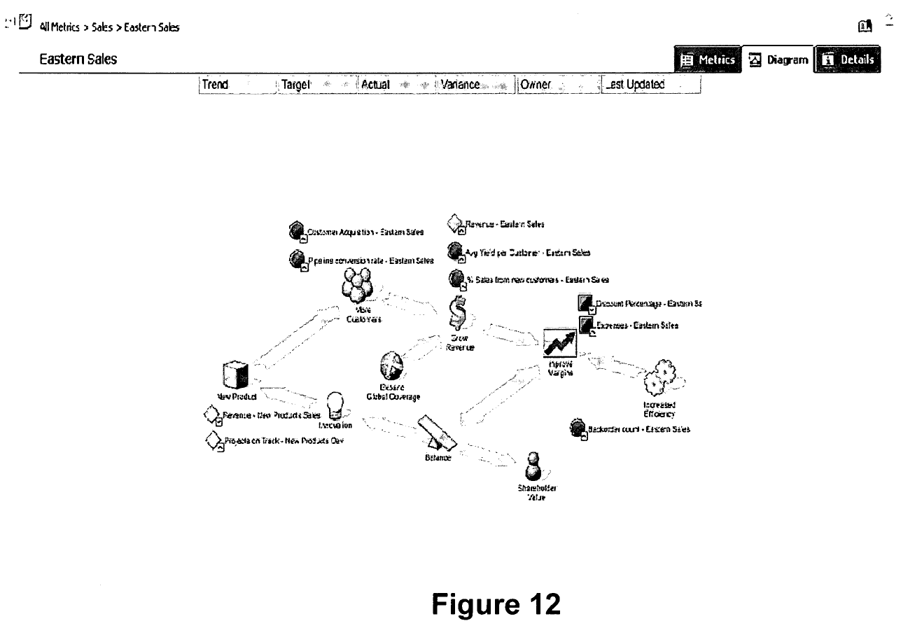

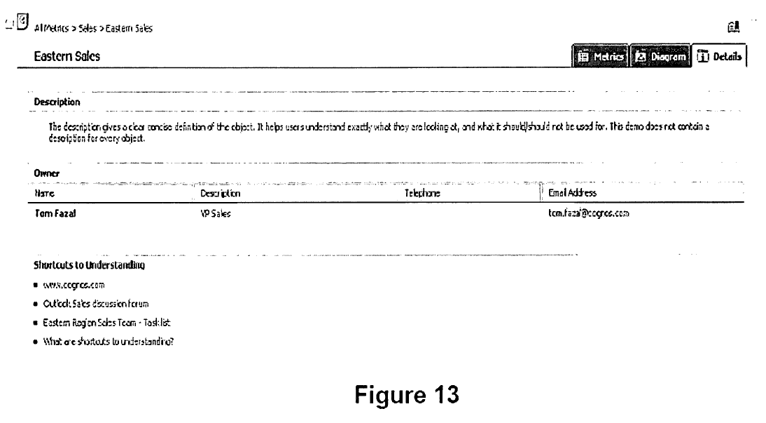

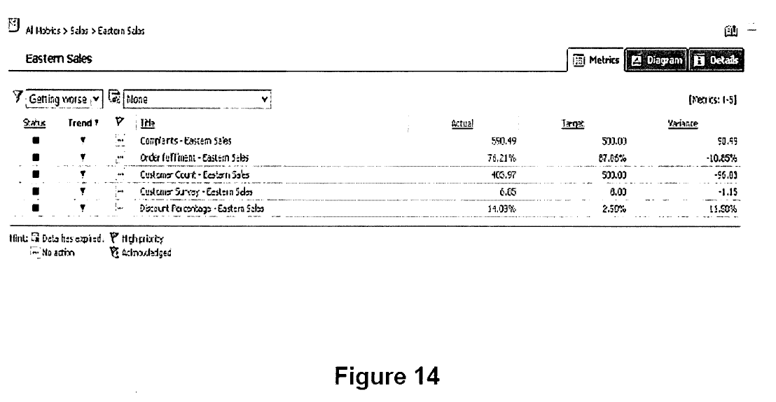

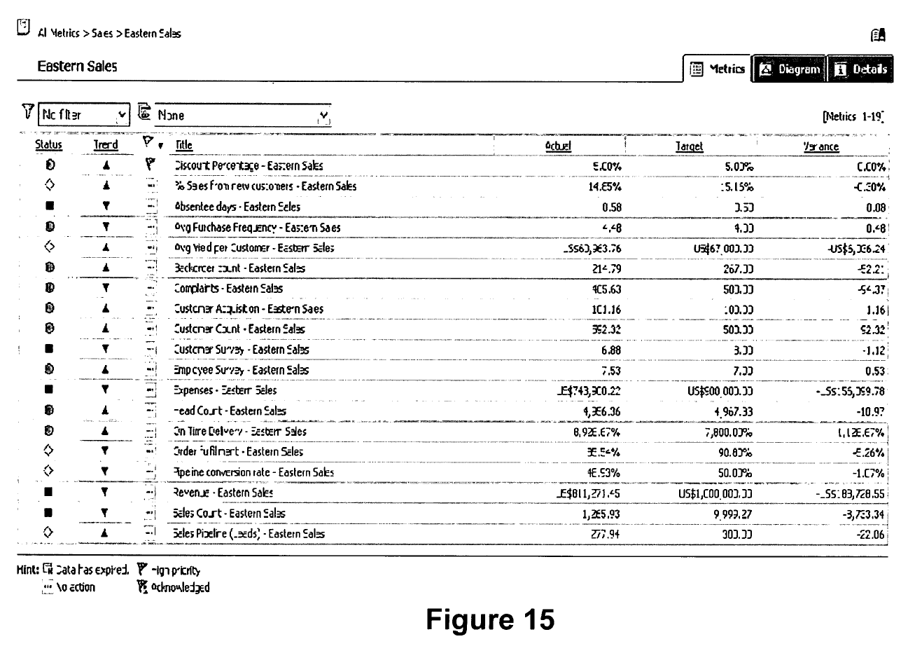

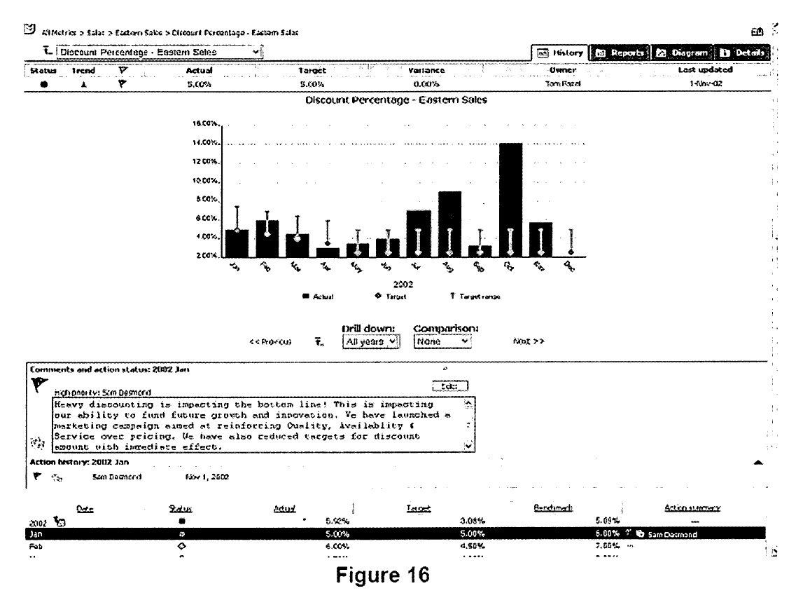

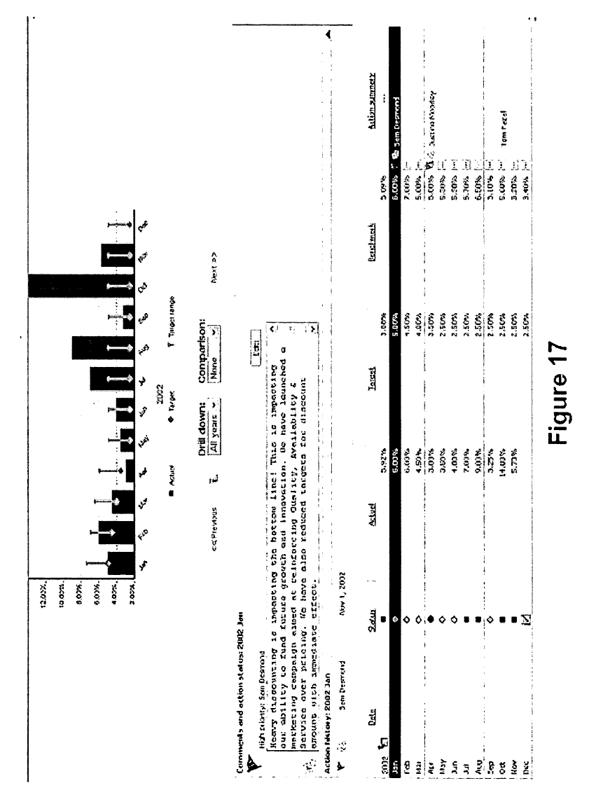

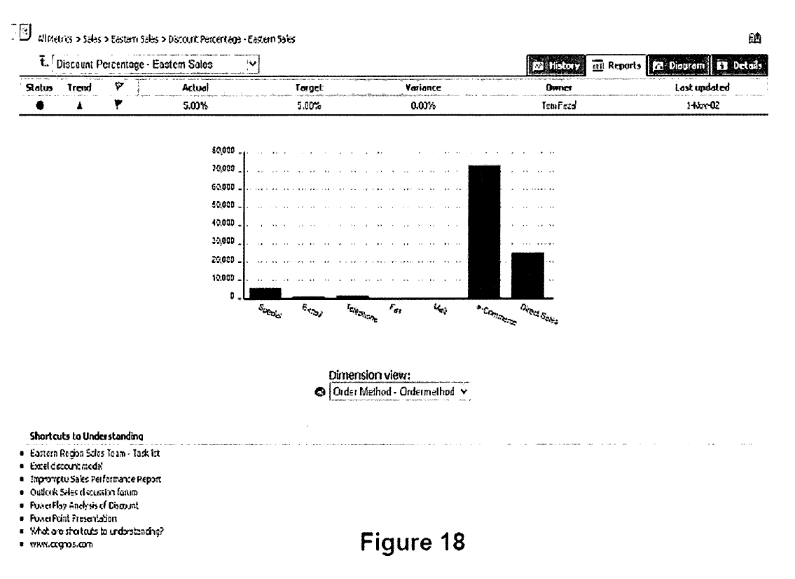

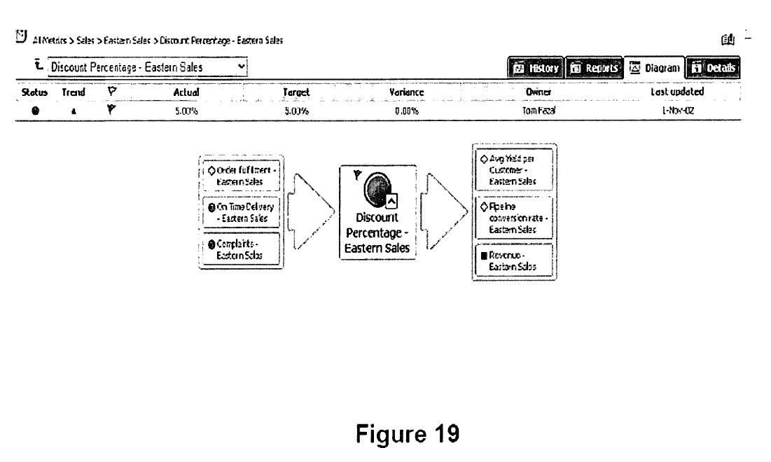

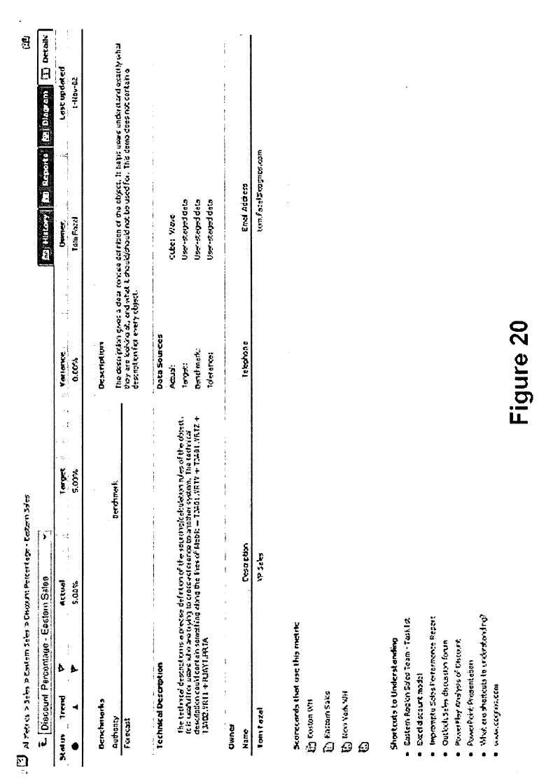

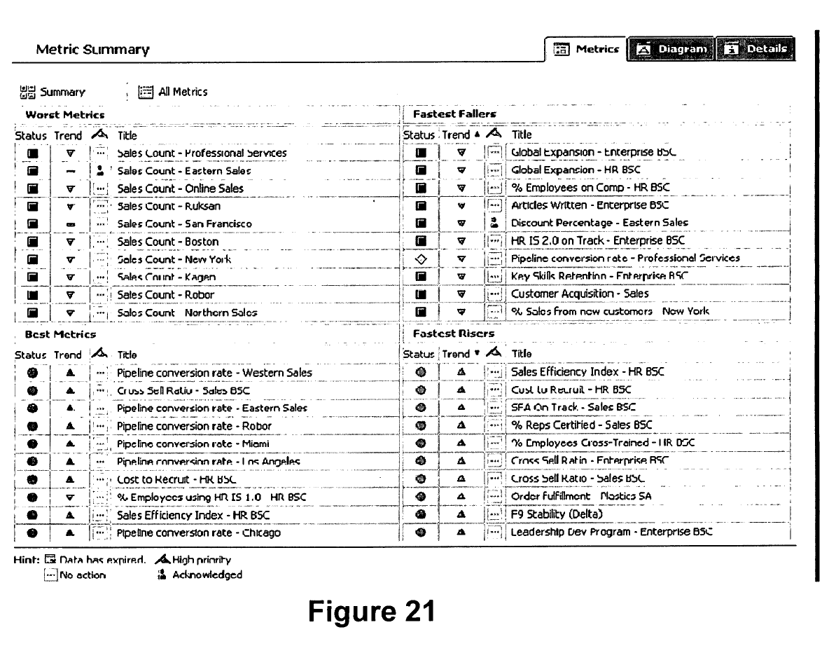

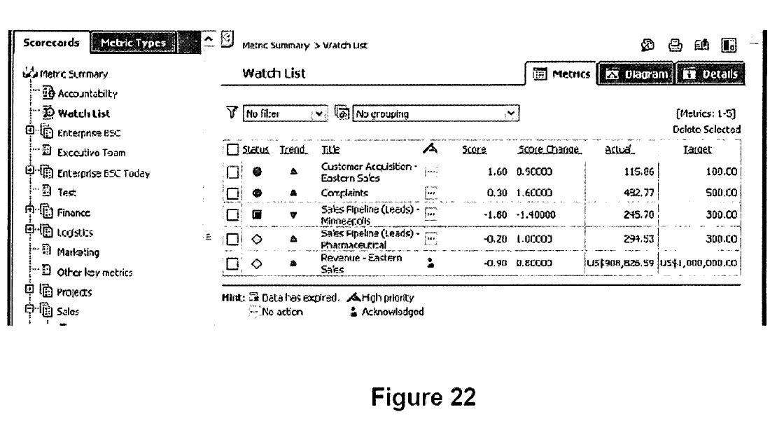

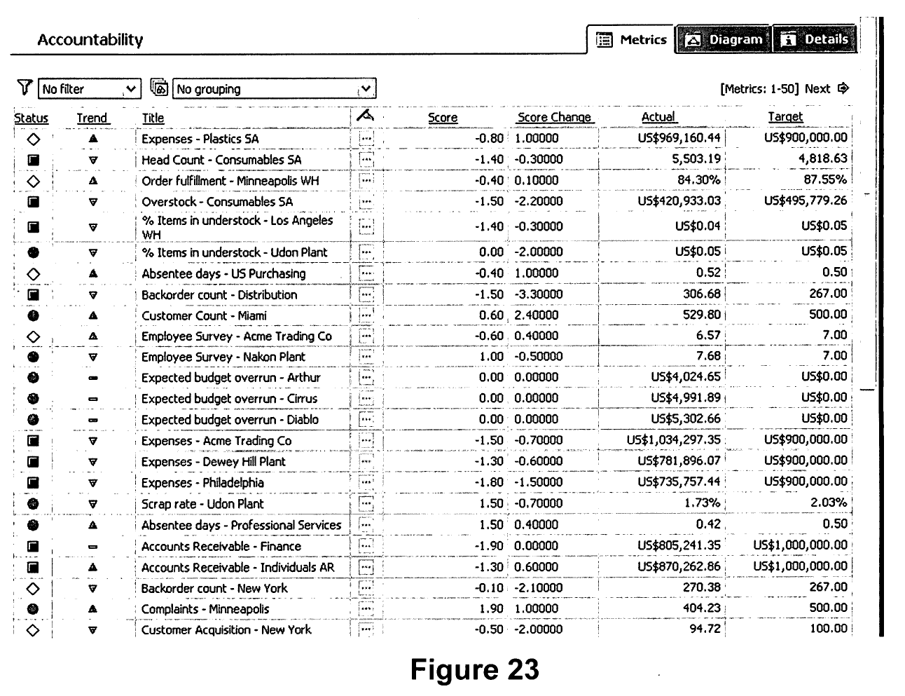

FIG. 11 is a screen shot showing an example of presentation of performance information;

FIG. 12 is a screen shot showing another example of presentation of performance information;

FIG. 13 is a screen shot showing another example of presentation of performance information;

FIG. 14 is a screen shot showing another example of presentation of performance information;

FIG. 15 is a screen shot showing another example of presentation of performance information;

FIG. 16 is a screen shot showing another example of presentation of performance information;

FIG. 17 is a screen shot showing another example of presentation of performance information;

FIG. 18 is a screen shot showing another example of presentation of performance information;

FIG. 19 is a screen shot showing another example of presentation of performance information;

FIG. 20 is a screen shot showing another example of presentation of performance information;

FIG. 21 is a screen shot showing another example of presentation of performance information;

FIG. 22 is a screen shot showing another example of presentation of performance information; and

FIG. 23 is a screen shot showing another example of presentation of performance information.

### DETAILED DESCRIPTION OF THE PREFERRED EMBODIMENTS

Referring to FIGS. 1A and 1B, a system and method for presenting performance information according to an embodiment of the present invention is described. The performance information user interface system 10 is suitably used to present performances information of an organization without limiting to a specific department in the organization. The business of the organization may or may not be of profitable.

The user interface system 10 comprises a KPI provider 12, option provider 14, selection receiver 16, performance information provider 18 and sorter/filter 20.

The KPI provider 12 displays a list of Key Performance Indicators (KPIs) (30). A KPI is an indicator which is useful to measure performance of an aspect of the business. KPIs may relate to various levels of summarization of data. For example, a Revenue KPI indicates a total revenue of the organization, and a North America Revenue KPI indicates a revenue of the North America for the organization.

According to the embodiment of the present invention, the KPIs have delta indication scores. A delta indication score indicates a change in its associated KPI. It is calculated based on new data and historical data of the KPI. The delta indication score indicates improvement or degradation. Delta indication scores may be shown on a list of KPIs by changed percentages, or shown symbolically using, such as arrow marks representing improvement or degradation.

The option provider 14 provides display options for presenting performance information of KPIs (32). The user interface system 10 allows and supports many different ways to access data and numeralizes and/or visualizes data in many different manners so as to support different performance management behaviours. The display options may include options for sorting and/or filtering and options for display formatting and organization, as further described below.

A user selects one or more display options while viewing and navigating through the results. The selection receiver 16 receives the selection of one or more display options (34). The user interface system 10 sorts and/or filters KPIs by the sorter/filter 20 according to the selected display options (36). The performance information provider 18 presents the performance information of the KPIs as sorted and/or filtered according to the selected display options (38).

Thus, the user interface system 10 allows users to monitor KPI data through various data guided monitoring methods using the scores of KPIs.

For example, if a user monitors KPIs using changes in the performance of KPIs, the user selects a sorting option to sort KPIs based on the delta indication scores. FIG. 1C schematically depicts an example 42 of a resultant display in which KPIs are listed and sorted from the biggest degradation at the top of the list to the biggest improvement at the bottom of the list. The sorting order may be reversed in response to a user selection. This presentation provides the user performance information as to what are the KPIs that are changing and how much they are changing. If a KPI is unchanged, the user typically does not need to know about the KPI because the user typically does not need to act on the unchanged KPI. Accordingly, prior to displaying the KPIs, the user interface system 10 may filter out KPIs that are unchanged so that users are given only those KPIs that are changing. The user interface system 10 may prompt users to select whether unchanged KPIs are to be included in the list.

Another example of the method of managing performance is managing by variance. A user selects a sorting option to sort KPIs based on the variance indication scores. FIG. 1C schematically depicts an example 44 of a resultant display in which KPIs are sorted from the worst KPIs at the top of the list to the best KPIs at the bottom of the list. The sorting order may be reversed in response to a user selection. This presentation provides the user performance information as to what KPIs are good or bad relative to their targets. When a user selects to look in detail just at the bad KPIs, the user interface system 10 may filter out good KPIs and intermediate KPIs as the user does not necessarily have to take action on them. The user interface system 10 may prompt users to select whether good KPIs and intermediate KPIs are to be included in the list.

The user interface system 10 further allows users to apply filters 46 based on multiple scores. Application of multiple score based filters 46 allow users to ask more complex questions of the data. For example, when the user asks to show “the bad KPIs that became worse”, the user interface system 10 achieves this query by applying a filter 46 to the KPIs to filter out only the bad ones and then sorting by the amount of change of KPIs showing the biggest degradation at the top of the list as shown in the example 48. The result 48 answers the user question by showing the user only the bad KPIs with degrading changes.

In the examples shown in FIG. 1C, the monitoring is carried out through data guided monitoring methods. The results are listed in a selected order.

The user interface system 10 may provide a metrics summary display. The metrics summary display shows best KPIs, worst KPIs, fastest rising KPIs or fastest falling KPIs on a single screen.

The user interface system 10 may allow results to be presented using various structured monitoring methods. FIG. 1D shows some examples 52-58 of the monitoring results where changes in the data are readily brought forward highlighted to users. Some users like to view data in a highly structured way. In an embodiment, the user interface system 10 supports such demand through three main structured monitoring methods: an ordered list 52, a hierarchical tree 54 and diagrams 56 and 58.

The ordered list 52 allows a user to put KPIs in an order that is suitable for the user because the KPIs are in a priority order, because the user can constantly view the KPIs that roll up to one another, or other reasons. The examples 42, 44 and 48 shown in FIG. 1C are presented using this type of structured monitoring method. In the ordered list 52 typically multiple columns are provided to show various metrics of KPIs. For example, columns may include Status, Trend, Title, Action Flag, Score, Score change, Actual and/or Target. The user interface system 10 may allow users to configure the list of available columns. FIG. 1J shows an example of a column configuration dialog. From the system's preferences box, the user may select “columns” which provides a list of available columns. From the list of available columns, the user can select desired columns by, e.g., dragging the name of a desired column to a “selected columns” list or highlighting the name of a desired column and using an arrow key. The user can also deselect undesired columns from the “selected columns” list. Once the user creates a list of “selected columns” as desired, the user can select “OK” to effect the selection. The user interface system 10 may allow the user to sort the KPIs by any columns by, e.g., selecting the column name on the list 52.

Referring back to FIG. 1D, the hierarchical tree 54 relates to the ordered list 52, but KPIs are hierarchically arranged in a tree structure. Diagrams 56 and 58 shows a graphical representation of KPIs in diagrammatical format. Diagram 56 uses a geographical map representation. Diagram 58 uses the relationships between KPIs. There may be many variation of diagrams. The formats of these various display methods are preset by an administrator of the user interface system 10. The user interface system 10 provides presentation method options so that users can select preferred presentation methods.

While in this embodiment, three structured monitoring methods are used, in a different embodiment, more or less of the same or different structured monitoring methods may be used.

The user interface system 10 may also provide users with various means of organizing or grouping KPIs for monitoring performance. The grouping functionality allows users to group KPIs into preset groups. The user can monitor KPIs as groups and only open any interested group to see individual KPIs when information of individual KPIs is needed. KPIs can be grouped according to the management strategy. Thus, grouping also allows the management to communicate strategy through how to group KPIs. Grouping allows display of KPIs with the balanced scorecard strategy better than flat lists.

In an embodiment, the grouping functionality uses grouping controls, groupings and group indicator counter.

The grouping controls allow users to choose how they want to group the KPI list. The grouping controls reside on top of the scorecards and indicator types. The grouping controls provide a dialog and/or dropdown menus in a preferences setting section of the user interface system 10. Through the dialog and/or dropdown menus, users can save grouping as the default way to see a scorecard.

FIG. 1F shows an example of a preference dialog which provides a section for choosing the type and level of grouping for scorecards and indicator types. It allows the user to select a home scorecard, default order of indicators, default scorecard grouping, default language, default currency and indicator status style. The default grouping provides a dropdown to selects how KPIs are grouped on scorecards by default. The default order of indicators is used to sort indicators on a selected column. On a specific scorecard or indicator type, the controls provides a grouping dropdown menu as exemplified in FIG. 1G. This dropdown menu contains viable grouping options predefined through an administration tool. For example, when the user selects to group KPIs by a group type, the flat list is grouped under the actual groups within that type. If a KPI does not belong to any group, then it may be grouped in a “other” group.

The group indicator counter counts the number of KPIs in the group in each state and provide a running total. If the KPIs are filtered, it counts KPIs as filtered.

There are two types of groupings: single level groupings and multiple level groupings. Single level groupings present one or more group names with their group indicator counters and KPIs, i.e., single level groupings provide only one group before KPIs are displayed. FIG. 1H shows an example of a single level grouping. KPIs are grouped by Financial, Customer, Internal and Learning & Growth in this example.

Multiple level groupings present one or more group names with their group indicator counters and KPIs in multiple levels. FIG. 11 shows an example of a two level grouping. In this example, KPIs are grouped by Financial, Customer, Internal and Learning & Growth, and then further grouped by a low level grouping. For example, the Financial group is further grouped by Exceed growth in key segments, Grow revenue from current customers, improve productivity and Drive profitable growth. The lower level groups may be collapsed until selected. Selecting by, e.g., clicking on a group, the group opens revealing the lower level groups or the KPIs below.

The grouping functionality may provide the information about groupings in a box that can be selected for a KPI.

In an embodiment, the user interface system 10 provides four KPI grouping methods: organizing through a folder structure, organizing through projects, organizing through KPI types, and presenting all indicators.

The first example is organizing through a folder structure where the nodes in the folder structure represents organizational units. For example, there may be a North American unit at the top. The North American unit may be divided into two unites: Production and Operations. The Operations unit is divided into two units representing two different types of products. This folder structure may be displayed as follows:
North America
   ^{L} Production
   ^{L} Operation
   ^{L} Product 1
   ^{L} Product 2
      By grouping KPIs under the folder structure, a user can easily select a folder that contains KPIs that are relevant to the user and describe the performance of the individual organizational unit.

The second method of organizing KPIs is through KPI types. KPIs may be categorized by their types. This method is used to look at a list of KPIs in a KPI type. The following is an example in which the organization method provides, for Revenue, options to review data as a break down of Revenue for different Products or different Regions:
Expense
Revenue _{T} Products
   ^{L} Regions
Inventory Levels

This organization method example allows a user who is primarily in charge of a financial measure, e.g., Revenue, to get an overview in a list of all revenues. The user can apply some of the monitoring methods, e.g., sorting and/or filtering by variance indication scores or by delta indication scores, in looking at a KPI type or folder, as described above.

The third method of organizing KPIs is through projects or initiatives. An organization typically has multiple projects. For example, the following display allows a user to request the KPIs that drive a particular project:
Project A
Project B
Project C
   When the user selects Project B, the user interface system 10 displays KPIs relating to Project B. The user may use some of the monitoring methods to review the related KPIs, as descried above.

When a user requests all the KPIs, the user interface system 10 displays all KPIs. There is no organization of the KPIs. The user interface system 10 displays any KPIs that is within the whole organization, and allows the user to explore the list of all KPIs. The list will answer to the questions of “just show me what are the worst things in this organization” or “what are the things that are degrading the fastest” by sorting and/or filtering the KPIs according to user's selection of monitoring methods, as described above.

While in this embodiment, four organizing methods are used, in a different embodiment, more or less of the same or different organizing methods may be used.

The user interface system 10 may also provide various methods of analysing and understanding of business performance. The analysing methods are used once users have found a specific KPI on a list of KPIs that warrants further attention. FIG. 1E shows some examples of analysing methods.

The first example of an analysing method is to present a trend chart 60 to show what has happened to a selected KPI over time. The trend chart 60 may show the actual values of the selected KPI, together with target values, tolerance values, benchmarks and/or forecast values.

Another example is to present a graph 62 to provide dimensional insight into a particular KPI. The graph 62 has drill down options 64. For example, a user is looking at a particular KPI, for example, Revenue in North America. The user interface system 10 breaks down the Revenue KPI to present an overview 64 of how the KPI is broken down by Products, how it is broken down within North America into the different Regions, by Sales Organizations, by Promotions and so on. The user selects a break down as desired to see the details.

Another example is to provide links 66 to related information 68 outside the user interface system 10. When a user is using analysing methods, the use has already identified a specific KPI to analyze. The user knows that there is an anomaly for the KPI, and wants to look at the information related to the KPI to see what the anomaly is. The user can simply select a suitable link 66 to reach the related information. The related information may be stored as reports, cubes, web pages, spreadsheets, or other formats that is accessible from a link, preferably using a URL. For example, the related information that the user wants to view is Sales Forecasts which exists in a report related to a matrix. By providing a link to the report within the user interface system 10, the user does not have to go out of the system 10 and find the report through some other means.

Once a user has located a specific KPI of interest, the user can also go back to lists of information that might be relevant to the user. An embodiment of the user interface system 10 provides different lists of KPIs from different aspects. For example, the user is looking at Revenue for a particular organization. The user interface system 10 provides a list 70 of other KPIs 70 that describe this organization. By using the list 70 of other KPIs for the particular organization, the user may analyze if the organization is performing badly in a certain area or the organization is performing badly in many areas. Also, the user interface system 10 provides a list 72 of the same KPI in other organizations. By using the list 72 of different organizations for the same KPI, the user can see if this anomaly only exists in their organization or it is prevalent in other organizations.

Another example of an analysing method is to present a cause and effect diagram 74. The cause and effect diagram 74 is a way of documenting what might be the causes 76 of the performance of a selected KPI 78. The cause and effect diagram 74 also shows what will be the effects 80 of the selected KPI 78. The user interface system 10 allows users to navigate through the diagram 74, i.e., allows a user to select a KPI which is shown as a cause or effect in the diagram 74, and change the display to show a new cause and effect diagram for the newly selected KPI. By navigating through the cause and effect diagram 74, the user can analyze and describe the causes of their performance trend and dimensional or insight, and may find the root cause of problems. The relations among KPIs may be automatically or manually preset when the KPIs are defined.

Another example of analysing methods is to provide notes 82. Notes 82 are users' annotations that they have added about data. If a user in an organization has already discovered the reason for an anomaly, the user interface system 10 allows the user to add the reason to the data as a note 82, and make the note 82 available to other users so that redundant efforts in finding the same reason by other users can be eliminated.

Another example is to provide information 84 about the KPIs. The information 84 may be a series of basic information about a KPI, such as the definition of the KPI or a description of how to calculate the KPI. By providing the information 84, users know precisely what the KPI is made up, what it includes, what is excluded, how it is calculated, and/or what the data source of any information is.

The user interface system 10 may also allow users to create a personal scorecard or “watch list”, i.e., a list of KPIs for which users like to monitor the metrics. Users can add or remove any KPIs to their watch list.

The user interface system 10 may further allow users to view an “accountability scorecard” that includes all KPIs for which the user is responsible.

While in this embodiment, ten analyzing methods are provided, in a different embodiment, more or less of the same or different analyzing methods may be provided.

The user interface system 10 may use flags to allow users to indicate special information on selected KPIs. For example, the system 10 may provide a high priority flag and/or an acknowledged flag.

The user interface system 10 may allow users to combine various monitoring, organizing and analysing methods to view desired data.

The user interface system 10 described referring to FIGS. 1A-1E may be suitably used with a performance monitoring system 100 shown in FIGS. 2A and 2B. The performance monitoring system 100 is suitably used to monitor business performances of an organization. The business of the organization may or may not be of profitable.

FIG. 2A illustrates a business overview of the performance monitoring system 100, showing the general functions of the performance monitoring system 100. The performance monitoring system 100 takes data 110 and organizes it into a performance related data repository 120. Data 110 may be stored in one or more data sources. Typically most organizations store data in multiple data sources. When data 110 is taken, the performance monitoring system 100 typically filters the data with some criteria and transforms it into performance related data which is in a suitable form for the performance monitoring system 100 (160).

The performance related data repository 120 stores performance related data that describes topics such as the strategy of the organization, indicators that are important to understand the business performance, i.e., Key Performance Indicators (KPIs), and to whom the KPIs are important, accountability for aspects of organizational performance, actual and target values of indicators over time, the history of values and any annotations including comments that users make about performance.

The performance related data repository 120 also covers usage and impact analysis. For example, the performance related data repository 120 can be used to analyse which users using which indicators, and which indicators are cross references to which other objects in the repository 120.

The performance monitoring system 100 provides users with information 140 about the performance of their organization by taking data 110 and transforms it into the performance related data repository 120. For example, the performance monitoring system 100 provides users with relevant performance metrics of things that are relevant to the users. The metrics gives the users at-a-glance monitoring of the relevant things, e.g., what business activities are on track, what are not on track, which are getting better and which are getting worse. The performance monitoring system 100 provides the at-a-glance monitoring in a way that allows users different ways of monitoring. The users can monitor in ways that are conducive to their own style of management. The performance monitoring system 100 not only allows users to follow pre-defined navigation paths and structures that they have set up, but also allows users to be guided by what has been happening in the data.

The performance monitoring system 100 also uses the performance related data repository 120 to link performance related data to other sources of information that assist users to have a thorough understanding of what is going on, and to analyse and find the causes of any performance anomaly. The performance monitoring system 100 also encourages sharing of human insights on performance related data by allowing users to feedback (170) their comments into the performance monitoring system 100 which are then available for other users to view.

FIG. 2B is a technical overview of the performance monitoring system 100. The performance monitoring system 100 comprises staging area 210, loader 220, KPI store 230 and an information presentation unit 260. The information presentation unit 260 comprises an application server 240 and a front-end interface 250.

The performance monitoring system 100 takes data from one or more data sources 280 that stores data relating to business performance. Examples of potential data sources 280 include typical data sources that organizations generally use, such as, Multidimensional OnLine Analytical Processing (MOLAP) cubes 281, relational data warehouses 282, other relational data source 284, such as Enterprise Resource Planning systems (ERPs) or custom developed systems, and other data source 284 such as legacy systems or textural data, e.g., Exel. All of these are potential data sources for business performance data.

The performance monitoring system 100 accesses data sources 280 through a data load mechanism. For example, the performance monitoring system 100 may use a utility PPXO 290 uses for Cognos Power Cube or MOLAP Cube 281. The utility PPXO 290 automatically extracts data from the cube 281 and loads it into the staging area 210. For relational data warehouse 282, other relational data source 283 or other data source 284, the performance monitoring system 100 uses custom load scripts or Extract, Transform, Load (ETL) process 292 to extract the data from the source and move it into the staging area 210.

The staging area 210 receives data from data sources 280. Loads of the staging area 210 do not impact performance of the system 100. Thus, it is possible to load the staging area 210 at any time of day. The staging area 210 is used primarily for bulk loading of data and metadata. It is desirable that the staging area 210 contains the data that has changed since the last run, rather than the entire data including unchanged data. The performance monitoring system 100 does not have to rebuild the entire staging area 210 for each load of data.

The staging area 210 is read by the loader 220. The loader 220 has a load function and a calculation function. The loader 220 reads the staging area 210 and moves data into the KPI store 230 at the same time transforming and scoring the data to output performance information which is in a form suitable for the use by the performance monitoring system 100. The loader 220 also calculates scores for numeric KPIs. A score is a numeric indication of the performance of a particular KPI.

KPIs to be stored in the KPI store 230 are preselected by a system administrator to reflect the business performance. For example, if 90% of the revenue in North America come from the sales of top 10 products, the system administrator selects the sales of these ten products as KPIs to monitor as well as the revenue in North America as another KPI. The performance monitoring system 100 provides users with performance information of the revenue in North America as represented by the ten products, while allowing users to drill down for each product. Thus, the users can understand the overall tendency of the performance at glance, as well as the performance of each product by drilling down to each product. In existing monitoring tools, the designer of tools could select only a relatively small number of KPIs in order to fit the monitor results within pre-set views. In the performance monitoring system 100, large number of KPIs can be sorted and/or filtered as viewer's selection to display desired results, as described above.

The KPI store 230 stores the performance information including values of Key Performance Indicators (KPIs) and other relevant data. Once the performance information is in the KPI store 230, the information is made available to users through the information presentation unit 260.

The user information presentation unit 260 typically uses a web application server 240 and a web based front-end interface 250. The front-end interface 250 provides users with business performance information, e.g., insight as to what is going on in their business, allowing the users to manage any problems found in the business performance. The front-end interface 250 presents the performance information in a way to guide users' monitoring sessions and their exploration of performance.

Examples and details of each element of the performance monitoring system 100 are further described referring to FIGS. 3-12.

FIG. 3 is an example data structure 300 in the staging area 210. The staging area 210 can contain values of various value types and aggregate data from different data sources.

The data structure 300 contains a series of data columns 310-312 relating to the time under which any particular row of staging area data is registered. The data structure 300 shows year 310, month 311, and day 312 to which the data applies. The staging area data structure 300 also contains columns relating to reference 313, value type 314, value 315, source 316, and date 317. The reference 313 is the method of describing what KPI the row indicates. The data structure 300 can contain not only actual values, but also target values or any other user defined values such as forecast values, or benchmark values. The value type 314 indicates which value 315 is stored in the relevant row. The source 316 indicates a data source from which the data comes. The date 317 indicates when the data reached the staging area 210.

For example, the first row indicates that for the full month of May 2002 a target value defined for Revenue in North America on May 21, 2002 is $5,000,000 according to SAP. The second row shows that a forecast value for the full month of May 2002 that was gathered on May 21, 2002 from Excels Force Automation system (SFA) is $5,120,350.

The staging area 210 receives daily actual values in a more detailed level than target and forecast values. For example, the third low in the data structure 300 shows that, on the first of May, the staging area 210 received actual values from three different systems for Revenue in North America: $54,742 from a Point-Of-Sale (POS) system, $28,353 from a web system and $10,843 from a contracts cube.

It is desirable that the staging in the staging area 210 is incremental, i.e., the staging area 210 stages only new values that have changed or added since the last stage because the full data set does not have to be provided for the KPI store 230 each time in corporation with the loader 220 as described below. The staging area 210 may be configured in two ways for each KPI: for a new value received during a selected time period, replace the new value for an existing value in the KPI store 230, or add the new value to the KPI store 230. For example, the staging area 210 shown in FIG. 3 received new actual values of $54,742, $28,353 and $10,843. If the KPI store 230 already stores a value of $2,500,000 for Revenue in North America, the staging area 210 may be configured to replace the $2,500,000 with the sum of the actual values, or to add the sum of the actual values to the $2,500,000.

FIG. 4 shows an example of a process 400 carried out by the loader 220 which transforms and scores the received data to load it into the KPI store. The loader process 400 performs a series of transformation and/or calculation actions 440 triggered by events 420. Events 420 are things that happen within the business or within the data set that requires the loader 220 to perform some action or actions.

Examples of events 420 include new data added to the staging area 210 (422), changes to user entered actual or target values (424), changes in definition or calculation methods (426), new KPIs registered in the performance monitoring system 100 (428) and update of data sources (430).

When new data is added to the staging area 210 (422), the new date is processed by the loader 220 if the new data affects one or more KPI value, e.g., a target value, actual value or other value.

The loader 220 preferably has a function to determine which value is a new value by comparing the received value and a corresponding value stored in the KPI store 230. The loader 220 loads only new values to the KPI store 230. Thus, not all of the data is loaded into the performance monitoring system 100 from data sources 280. Certain values are not available in data sources 28, such as some of target values and actual values that need assessment by users. Those values are captured inside of the performance monitoring system 100, i.e., users enter those values into the performance monitoring system 100. Users may change those user-entered values (424). An example of a change in a target value is that when a target for Revenue for a particular year was originally set as $5 million, the performance monitoring system 100 has automatically prorated the $5 million target over the 12 months. In half way through the year, the user revises the target value to $5.5 million. The loader 220 recalculates the prorating based on the new target value, and also recalculates the performance related data and any scores or status that have been calculated based on those target values, as further described below.

Users may also change the definition of KPIs or calculation methods (426). An example is that a change is made in a calculation method of a Customer Satisfaction Index. Initially the Customer Satisfaction Index was calculated as a result of two other KPIs, one of them being Survey Results and another one being Returns. The new calculation method also uses Repeat Purchases as another KPI to calculate the Customer Satisfaction Index. The new calculation method means that the values of the calculated KPI are redefined.

When a new KPI is added and registered into the performance monitoring system 100 (428), the performance monitoring system 100 now has a KPI that has never been reported before where the performance monitoring system 100 has been in production on the system data for a year already. For example, when a Maintenance Renewal Rate is added to the performance monitoring system 100, the loader 220 attempts to source historical data for that Maintenance Renewal Rate, not just from the day when it is added, but also from the prior history as far back as the other KPIs are loaded or as far back as the user indicates.

When a data source is updated (430), some actions of the loader 220 are also triggered. In the example shown in FIG. 3, three data sources are used to obtain actual values. If the contracts cube was last updated on May 15, SAP was last updated on May 30, and the POS system was last updated on May 22, the data displayed by the performance monitoring system 100 mean differently among those actual values. The data shown for the contracts cube on May 30 that the performance monitoring system 100 is able to display to a user was updated on May 15. This means that even though the data is viewed at May 30, the last time the performance monitoring system 100 loaded the data was May 15 and accordingly, the value looks low. Also, it is relevant to the performance monitoring system 100 to know which data was updated on which date. If the contracts cube is to be updated, for example on May 25, there may be some KPIs for which the performance monitoring system 100 receives no data. In order to reflect the fact that the data source 280 has been updated even though the performance monitoring system 100 have received no data in the staging area 210, that the performance monitoring system 100 prorates the target value so that the user can know that the data is as of May 25 and the target value should have increased. If no data was received, while the data sources are updated, it means that the business is doing worse than the performance on May 15, even though the actual value displayed is unchanged. Thus, the loader 220 processes when the data sources are updated to provide correct views of the business to the user.

Now referring to the flowchart 441, examples of actions 440 that are performed on these events 420 are described. The actions 440 are described in the order of the flowchart 441, but all actions may not be taken every time or additional steps may be taken as needed. Also, these actions may be taken in a different order.

The loader 220 looks at whether any new KPIs exist for publishing (442). The loader 220 determines the net effect of any new data added to the staging area 210, changes entered to actual values or other values, or changes in calculation methods (444). Thus, the performance monitoring system 100 determines differences or changes for KPIs. For example, the original Revenue before new data added to the staging area 210 was $5,000,000. The performance monitoring system 100 received at the staging area 210 a new value of $500,000. The net affect is $500,000. The loader 220 is preset to add the $500,000 to the original $5,000,000, and calculates a new updated set of KPI values reflecting the new value of $5,500,000. The loader 220 updates the KPI values according to the calculated new values (446).

The next step is prorating target values (448). For example, the performance monitoring system 100 has a target value for the month of $50,000,000 for a particular KPI and the actual value achieved is $40,000,000 for the KPI. According to the non-prorated target of $50,000,000, it seems that the business is not doing too well as the actual value is below the target. However, the actual value was as of the middle of the month. Looking at the prorated target for the middle of the month is $25,000,000, the actual value of $40,000,000 at the middle of the month when the target is $50 million probably means that the business is doing well. Thus, using the prorated target values provides more accurate view of the performance.

The performance monitoring system 100 scores to monitor KPIs. There are different types of scores, including “good or bad” and “better or worse”.

The performance monitoring system 100 scores to evaluate how good or bad particular KPIs are, based on these prorated target values (450). Also, the performance monitoring system 100 may use tolerance values to calculate scores. This score indicates how good or bad the particular KPI is. The numeric scores may be converted into colour or pattern coded status for display to the user in the front-end interface 250. For example, the scores may be presented as red (bad), yellow (neutral) and green (good).

The performance monitoring system 100 can also compare values from period to period to know whether the KPI has improved or worsen. If a score changes from 100 to 110, the performance monitoring system 100 knows that the KPI has been improved relative to another KPI. KPIs may have different units. For example, one KPI may be monitory and another one may be a percentage. Both KPIs are scored to have a common unit. The scores allow the performance monitoring system 100 to compare different KPIs based on which one of KPIs is better or worse or which one of KPIs has improved the most or got worse in the time period at which the user is looking.

The ability with prorating target values and calculating scores supports the monitoring functions that the performance monitoring system 100 can perform, such as letting users to change target values and guiding users through changes in the values. Thus, the performance monitoring system 100 allows the user to manage problems in the performance. The performance monitoring system 100 provides users with monitoring means which functions more than simply looking at predefined structures of data that the user has set up to manage.

Continuing with the loader action process 441, the last step shown in FIG. 4 is that the performance monitoring system 100 calculates computed KPIs (452). Thee computed KPIs are any calculated KPIs which do not exist in the base data. For example, the performance monitoring system 100 calculates the customer satisfaction index that described above because the performance monitoring system 100 cannot obtain a customer satisfaction index from any data source. The user calculates this index based on what the value of survey results and returns to the performance monitoring system 100.

FIG. 5 shows an example of the repository of performance information in the KPI store 230. The KPI store 230 is a relational database that has three major statements of information therein. The three major statements are KPI values 510 themselves, business metadata and annotations 520, and technical metadata 530.

The KPI values 510 include the actual values, target values and scores over time. These values are stored by monthly 512 and daily 514. Each value is associated with the time 516, e.g., when the value is received, and a KPI 518 for which the value is received.

The business metadata and annotations 520 drive the exploration and ability to highlight related information for KPIs. Examples of the business metadata 520 that is used by the performance monitoring system 100 include what objections of the company are, what initiatives they have on the go, with which projects does the user work, and what critical success factors of the company are. The business metadata 520 also include scorecards, cause/effect relationships that exist between different KPIs, diagrams, reports which present value related information about a KPI, other documents and external links, such as web pages or policy documents that is available on line. The business metadata 520 may also contain any annotations that are entered by users describing the business performance. These business metadata and annotations 520 describe the strategy and allow the company to map back their performance to their strategy.

The technical metadata 530 drives the technical working of the performance monitoring system 100. The technical metadata 530 describes the data sources from which that the performance monitoring system 100 extracts data, the dimensionality, information of the data sources, the measures which are the building blocks of KPIs that exist in the data sources, metadata that drives the actual user interface and metadata which defines what currencies and languages are available to users of the performance monitoring system 100.

The KPI store 230 also has security 540 and language translations 550. The data and metadata in the database 500 is secured through an access control list by the security 540. This means that the database 500 stores which classes of users are allowed access to which data. The database 500 may also store language translations 550 of textual data so that the interface can be displaced in different languages.

FIG. 6 shows more details of how the KPI values 510 are stored in the database 500. The KPI values are stored in a relational cube 600. The cube 600 a dense cube that contains a value for each combination of items. A cell is provided for each combination regardless it has a value or not.

The cube 600 has two dimensions 610: time and KPIs themselves. Both time and KPIs support multiple roll-ups or break downs. For example, in time, users can roll-up and view data for a month or users can roll-up and view numbers view-to-date. For KPIs, users can roll-up KPIs into a number organizing them into a number of different ways. For example, users may ask questions such as “show me all KPIs of a particular type”, “show me KPIs that belong to a particular scorecard” or, “show me KPIs that support a particular strategic objective”.

The cube 600 has measures 620. The measures 620 of the cube 600 shown in FIG. 6 are the actual values, the target values, the prorated target values, the tolerance values, the scores that the loader 220 calculated to allow the performance monitoring system 100 to relatively assess good or bad and improved or degraded in performance. The cube 600 also supports user defined measures. Different KPIs can have different user defined measures. Users may have forecasts that they want to have displayed in the performance monitoring system 100 or they use the forecasts for benchmarks. For example, if a newspaper states that inventory turns for a particular industry should be 10, users may store this value as a benchmark value in this cube as a user defined attribute. Other measures may be a score change amount and value change amount. The score change amount is used to drive the reporting of improvement and degradation.

The KPI values 510 may also include cubes pre-aggregated by the loader process 220. The cube 600 contains a value for a predefined period. For example, if a user is looking at a year to date value, the performance monitoring system 100 does a direct read of that year to date value, rather than calculating the sum of values to date from the component months.

Referring to FIG. 7, the business metadata 520 is now further described. FIG. 7 shows a logical depiction 700 of the business metadata 520 and a physical representation 760 of how that would be stored in the database 500.

In the logical depiction 700, for example, there are three Indicators 711-713. Indicators 711-713 can be associated with various other objects in the database 500, such as Critical Success Factors 721, 722. Critical Success Factor 721 is measured by Indicators 711 and 712, and Critical Success Factor 722 is measured by Indicators 711 and 713. Indicator 711 is associated with both Critical Success Factors 721 and 722. Thus, the objects in the database 500 are stored in a loosely defined network 710, rather than a strict parent-child hierarchy.

The network 710 contains not just Indicators 711-713 and Critical Success Factors 721-722, it may contain other different types of objects to enable exploring Indicators by various angles of business. For example, in FIG. 7, the network 710 also contains Initiative 731 which is measured by Indicators 712 and 713, and Initiative 732 which is measured by Indicators 711 and 713. Also, Objectives 741-743 are included in the network 710. Objective 741 has Indicators 711 and 712 associated therewith. Objectives 741-743 have their own associations: Objective 741 is associated with Objective 742 which is a parent of Objective 743.

The physical representation 760 is a relational data model 770 which describes this logical network 710. The model 770 comprises three tables 771-773. In the centre, there is a content link table 772. Each content link in the content link table 772 describes a particular content object in the content object table 773 to which it is related. There is a row in the content object table 773 for each line in the content link table 772 and each line between each object.

The link type table 771 describes the type of relationship that exists between those objects. In certain cases it is possible to have a relationship between the same types of objects, but there may be a different type of relationship. An example of a different type of relationship is the cause and effect relationship. For example, a relationship exists between a KPI and a KPI that is a cause relationship, and another relationship exists between a KPI and a KPI which is an effect relationship.

FIG. 8 shows an example 800 of the web application server 240. The web application server 800 is provided between the web front-end interface 250 and the KPI store 230. The web application server 800 comprises a web server 810, servlet engine 811, authentication layer 813, servlet generators 814-816, servlets 817 and data access Application Programming Interface (API) 820.

When the web front-end interface 250 requests some data or a page of information, the request is fired off to the web server 810. The web server 810 is running the servlet engine 811. The generators 814-816 generate servlets 817. The generated servlets 817 perform the work for getting data and building web pages.

The servlets 817 access data from the database 830 of the KPI store 230 via the data access API 820. The data access API 820 calls stored procedures and functions 832 in the database 830 to get data 834 out of the database 830. Not all the data for the performance monitoring system 100 may be stored within the relational database 830 of the KPI store 230. Other web service 840 may be used to obtain data from other data sources, e.g., embedded link to data in other data sources. A servlet 817 extracts data from the web service 840 in a similar way to extract data from the relational database 830. It is desirable that all the data and pages requests are authenticated by the authentication layer 813, and the performance monitoring system 100 ensures that the requester is a valid user and also checks the data that the user is asking for to ensure that the user is authorized to view the data. The authentication may be done by another authentication server 850 through the authentication layer 813.

FIG. 9 shows an example 900 of the web front-end interface 250. The web front-end interface 900 is divided into three main areas: consumer front-end interface 910, diagram authoring front-end interface 930 and general administration front-end interface 950. The consumer front-end interface 910 is the dominant front-end used by consumers or business uses for their regular or ad-hoc monitoring tasks. The diagram authoring front-end interface 930 is typically used by business analysts to create new diagrams that business users have views in the consumer front-end interface 910. The consumer front-end interface 910 may also be useful for business analysts. The administration front-end interface 950 has its primary focus for IT personnel. IT personnel uses the administration front-end interface 950 to maintain mainly technical metadata around the performance monitoring system 100, such as how the performance monitoring system 100 is configured for this particular case, what the data sources are and what the measures and dimensions are.

Returning back to the consumer front-end interface 910, the main function of the consumer front-end interface 910 is monitoring performance. The consumer interface 910 provides users answers to different types of business performance questions, such as what is going on in their business, which processes are performing well or badly, and which products are getting better or worse. The consumer front-end interface 910 presents a structured view of those processes. Not only does the consumer front-end interface 910 gives a high level indication as to for which processes organizations are doing better, well or badly, the consumer front-end interface 910 also gives the users further information to do some analysis to try and understand the root cause of any anomalies. The consumer front-end interface 910 also provides the facility for users to capture annotations to describe any performance anomalies, and share insights into performance and insights into what actions they have taken to improve the performance.

Another aspect of the consumer front-end interface 910 is that it allows business users to create and maintain their own scorecards. Based on KPIs that are already existing, other new scorecards can be assembled. Also the users can use KPIs from cubes or other data sources. If a KPI exists in a data source, such as Cognos Power Cube, users can point to that KPI and specify it so that the KPI is included in the performance monitoring system 100. The consumer front-end interface 910 also allows users to register their own reports and external content that are relevant to KPIs.

FIG. 10 shows an example 960 of the consumer front-end interface 910. The consumer front-end interface 960 has a viewer driven sorter 962, a viewer driven filter 964 and a metric selector 966.

The viewer driven sorter 962 allows business users, i.e., viewers who are monitoring the performance information, to sort the performance information during the monitoring operation. Similarly, the viewer driven filter 964 allows viewers to filter the performance information during the monitoring operation. By providing the viewer driven sorter 962 and filter 964, all of the performance information in the KPI store 230 can be made available for the monitoring as they can be sorted and/or filtered by the viewer to display the monitoring results of the desired information.

Furthermore, the metric selector 966 provides viewers options of several types of view formats or metrics, for presenting monitoring results. The metric selector 966 allows the viewer to select a preferred view metric type so that sorted and/or filtered performance information can be displayed in the selected view metric 970 in an intuitive manner. Also, the metric selector 966 provides the viewer with navigation control, i.e., the viewer can easily switch between different types of view metrics.

Thus, the system 100 can provide viewers with flexible viewer driven monitoring based on all of the KPIs available in the KPI store 230. This allows flexible intuitive monitoring of the entire business.

The consumer front-end interface 910 provides users with various monitoring methods, organizing methods and analysing methods as exemplified in FIGS. 1C to 1E and as discussed above.

The user interface presentations are demonstrated by some examples shown in FIGS. 11-20. In FIG. 11, on the left side of the display, the scorecards are listed in a hierarchy. When the user selects “Eastern Sales” in “Sales”, the metrics of KPIs of “Eastern Sales” are presented in a table in the right side section. The table has columns of status, trend, flag, title, actual value, target value and variance. The KPIs are not filtered or sorted. The user interface provides three tabs “Metrics”, “Diagram” and “Details”.

When the user selects a “Diagram” tab, a diagram as shown in FIG. 12. In the diagram, the KPIs are grouped, e.g., New Product, New Customers and so on, and arranged to graphically represent the relationship of the groups. The status and trend of the groups are also symbolically shown.

When the user selects a “Details” tab, as shown in FIG. 13, the details of the “Eastern Sales”. The presentation includes a description, owner information and shortcuts to understanding.

Back to the “Metrics” tab, FIG. 14 is similar to FIG. 11, but the KPIs are filtered by “getting worse”.

FIG. 15 is also similar to FIG. 11, but KPI “Discount Percentage—Eastern Sales” has a high priority flag assigned to it and shown on the top of the list.

When the user selects the KPI “Discount Percentage—Eastern Sales” from the list of FIG. 15, the history of the KPI can be presented in a graph and a table as shown in FIGS. 16 and 17. The description of the high priority flag is also presented.

The user may also view a report of details of the KPI as shown in FIG. 18, and a cause-and-effect diagram as shown in FIG. 19. The detail information of the KPI can be also viewed by selecting the “Details” tab as shown in FIG. 20.

Back to the “Metrics” tab again, the user may select “Metric Summary” to view the best KPIs, worst KPIs, fastest rising KPIs and fastest falling KPIs on a single screen as shown in FIG. 21.

The user may view metrics of selected KPIs by selecting a “Watch List” as shown in FIG. 22.

The user may also view metrics of all KPIs for which the user is responsible by selecting a “Accountability” as shown in FIG. 23.

These screenshots are presented here for examples. The same or similar information is presented to the user in many different manners and arrangements without departing from the scope of the present invention.

The performance user interface of the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention. For example, the elements of the performance user interface system are described separately, however, two or more elements may be provided as a single element, or one or more elements may be shared with other component in the performance monitoring system or other systems.

1. A method in a computer system for presenting business performance information, the method comprising steps of:
displaying a list of Key Performance Indicators (KPIs) having delta indication scores indicating changes in the KPIs;
providing display options;
receiving selection of a display option; and
presenting performance information of the KPIs based on the selected display option.

2. The method as claimed in claim 1 wherein
the displaying step displays the KPIs having delta indication scores which are calculated based on new data and historical data of the KPIs to indicate improvement or degradation of KPIs;
the receiving step receives selection of a display option including a sorting option for sorting KPIs based on the delta indication scores; and
the presenting step presents performance information of the KPIs as sorted according to the sorting option.

3. The method as claimed in claim 1 wherein
the receiving step receives a display option for filtering KPIs based on multiple types of scores; and
the presenting step presents performance information of the KPIs filtered based on multiple types of scores.

4. The method as claimed in claim 1 wherein the displaying step displays the KPIs further having variance indication scores which are calculated based on new data and target data of the KPIs to indicate differences from the target data of KPIs.

5. The method as claimed in claim 4 wherein
the receiving step receives selection of a display option including a filtering option for filtering KPIs based on the variance indication scores; and
the presenting step presents performance information of the KPIs as sorted and filtered according to the sorting option and the filtering option.

6. The method as claimed in claim 1 wherein
the presenting step presents the KPIs as grouped in multiple groups.

7. A system for presenting business performance comprising:
a KPI provider for presenting a list of available predefined Key Performance Indicators (KPIs) having delta indication scores indicating changes in the KPI;
an option provider for providing display options;
a selection receiver for receiving selection of a display option; and
a performance information provider for presenting performance information of the KPIs according to the selected display option.

8. The system as claimed in claim 7 further comprising a sorter for sorting KPIs, and wherein
the KPI list provider displays the KPIs having delta indication scores which are calculated based on new data and historical data of the KPIs to indicate improvement or degradation of KPIs;
the selection receiver receives selection of a display option including a sorting option for sorting KPIs based on the delta indication scores;
the sorter sorts the KPIs according to the received sorting option; and
the performance information provider presents performance information of the KPIs as sorted according to the sorting option.

9. The system as claimed in claim 7 wherein
the selection receiver receives a display option for filtering KPIs based on multiple types of scores; and
the performance information provider presents performance information of the KPIs filtered based on multiple types of scores.

10. The system as claimed in claim 7 wherein the KPI list provider displays the KPIs further having variance indication scores which are calculated based on new data and target data of the KPIs to indicate differences from the target data of KPIs.

11. The system as claimed in claim 10 further comprising a filter for filtering KPIs, and wherein
the selection receiver receives selection of a display option including a filtering option for filtering KPIs based on the variance indication scores;
the filter filters the KPIs according to the filtering option; and
the performance information provider presents performance information of the KPIs as sorted and filtered according to the sorting option and the filtering option.

12. The system as claimed in claim 7 wherein
the performance information provider presents the KPIs as grouped in multiple groups.

13. A method in a computer system for presenting business performance information of an organization, the method comprising steps of:
displaying a list of Key Performance Indicators (KPIs) for an organization;
receiving a selection of a specific KPI;
providing analyzing method options, each analyzing method option defining an analyzing method of presenting performance information of KPIs to be analyzed;
receiving a selection of an analyzing method; and
presenting performance information of one or more KPIs including the specific KPI according to the selected analyzing method.

14. The method as claimed in claim 13 wherein
the providing step provides analyzing method options including a relation analyzing method for presenting related KPIs for the specific KPI; and
the presenting step presents performance information of KPIs that are related to the specific KPI.

15. The method as claimed in claim 14 wherein the presenting step presents the related KPIs as a cause and effect diagram indicating that zero or more KPIs are causes for the change of the specific KPI, and zero or more KPIs receive effects of the change of the specific KPI.

16. The method as claimed in claim 15 further comprising steps of
receiving a selection of a related KPI; and
presenting performance information of KPIs that are related to the selected related KPI.

17. The method as claimed in claim 13 wherein the presenting step presents a higher level of the performance information of KPIs in a form that allows drilling down into a lower lever.

18. The method as claimed in claim 13 further comprising steps of:
providing organizing method options, each organizing method option defining an organizing method of organizing KPIs;
providing monitoring method options, each monitoring method option defining a monitoring method of presenting KPIs to be monitored;
receiving selections of an organization method and a monitoring method; and
presenting performance information of the KPIs based on the selected organization method and monitoring method.

19. The method as claimed in claim 18 wherein the organizing method options include an organizing method for organizing KPIs by organizational units, KPI types or projects.

20. The method as claimed in claim 18 wherein the monitoring method options include data guided monitoring methods defining sorting and/or filtering methods of KPIs.

21. The method as claimed in claim 20 wherein the guided monitoring methods sorts and/or filters KPIs using scores of KPIs.

22. The method as claimed in claim 18 wherein the monitoring methods options include a monitoring method for presenting KPIs in a diagram showing relations among preselected KPIs to allow users to navigate through related KPIs.

23. The method as claimed in claim 13 wherein
the providing step provides analyzing method options including a grouping method for grouping KPIs; and
the presenting step presents performance information of KPIs that are grouped according to the selected grouping method.

24. A performance information presenting system comprising:
a KPI provider for displaying a list of Key Performance Indicators (KPIs) for an organization;
an option provider for providing analyzing method options, each analyzing method option defining an analyzing method of presenting performance information of KPIs to be analyzed;
a selection receiver for receiving selections of a specific KPI and analyzing method; and
a performance information provider for presenting performance information of one or more KPIs including the specific KPI according to the selected analyzing method.

25. The performance information presenting system as claimed in claim 24 wherein
the option provider provides analyzing method options including a relation analyzing method for presenting related KPIs for the specific KPI; and
the performance information provider presents performance information of KPIs that are related to the specific KPI.

26. The performance information presenting system as claimed in claim 25 wherein the performance information provider presents the related KPIs as a cause and effect diagram indicating that zero or more KPIs are causes for the change of the specific KPI, and zero or more KPIs receive effects of the change of the specific KPI.

27. The performance information presenting system as claimed in claim 26 wherein
the selection receiver receives a selection of a related KPI; and
the performance information provider presents performance information of KPIs that are related to the selected related KPI.

28. The performance information presenting system as claimed in claim 24 wherein the performance information provider presents a higher level of the performance information of KPIs in a form that allows drilling down into a lower lever.

29. The performance information presenting system as claimed in claim 24 wherein
the option provider further provides organizing method options, each organizing method option defining an organizing method of organizing KPIs, and monitoring method options, each monitoring method option defining a monitoring method of presenting KPIs to be monitored;
the selection receiver further receives selections of an organization method and a monitoring method; and
the performance information provider presents performance information of the KPIs based on the selected organization method and monitoring method.

30. The performance information presenting system as claimed in claim 29 wherein the organizing method options include an organizing method for organizing KPIs by organizational units, KPI types or projects.

31. The performance information presenting system as claimed in claim 29 wherein the monitoring method options include data guided monitoring methods defining sorting and/or filtering methods of KPIs.

32. The performance information presenting system as claimed in claim 31 further comprising a sorter for sorting KPIs based on the guided monitoring methods using scores of KPIs.

33. The performance information presenting system as claimed in claim 33 further comprising a filter for filtering KPIs based on the guided monitoring methods using multiple scores of KPIs.

34. The performance information presenting system as claimed in claim 29 wherein the monitoring methods options include a monitoring method for presenting KPIs in a diagram showing relations among preselected KPIs to allow users to navigate through related KPIs.

35. The performance information presenting system as claimed in claim 24 wherein
the option provider provides analyzing method options including a grouping method for grouping KPIs; and
the performance information provider presents performance information of KPIs that are grouped according to the selected grouping method.

36. A computer readable medium storing the instructions and/or statements for use in the execution in a computer of a method for presenting business performance information, the method comprising steps of:
displaying a list of Key Performance Indicators (KPIs) having delta indication scores indicating changes in the KPIs;
providing display options;
receiving selection of a display option; and
presenting performance information of the KPIs based on the selected display option.

37. Electronic signals for use in the execution in a computer of a method for presenting business performance information, the method comprising steps of:
displaying a list of Key Performance Indicators (KPIs) having delta indication scores indicating changes in the KPIs;
providing display options;
receiving selection of a display option; and
presenting performance information of the KPIs based on the selected display option.

38. A computer program product for use in the execution in a computer of a method for presenting business performance information, the computer program product comprising:
a module for displaying a list of Key Performance Indicators (KPIs) having delta indication scores indicating changes in the KPIs;
a module for providing display options;
a module for receiving selection of a display option; and
a module for presenting performance information of the KPIs based on the selected display option.
